(19) United States
(12) Patent Application Publication
(10) Pub. No.: US 2003/0182653 A1
(43) Pub. Date: Sep. 25, 2003

(54) Systems and methods for verifying correct execution of emulated code via dynamic state verification

(76) Inventors: Giuseppe Desoli, Watertown, MA (US); Vasanth Bala, Tarrytown, NY (US); Evelyn Duesterwald, Somerville, MA (US)

Correspondence Address: HEWLETT-PACKARD COMPANY, Intellectual Property Administration, P.O. Box 272400, Fort Collins, CO, 80527-2400, US

(21) Appl. No.: 10/104,084

(22) Filed: Mar. 22, 2002

(51) Int. Cl. G06F 9/45; G06F 9/455; G06F 9/00

(52) U.S. Cl. 717/138; 717/139; 703/23; 709/328

(57) ABSTRACT

Systems and methods for verifying execution of translated code operative on a host computer system different from the computer system designated for the original program code. In one arrangement, the system and method fetch program code, translate program code, emit the translated program code into at least one code cache, execute the translated code within the at least one code cache, interpret the program code, and compare a translator generated state with an interpreter generated state to confirm desired code execution.

### FIELD OF THE INVENTION

This disclosure generally relates to dynamic transformation of executing binary program code. More particularly, the disclosure relates to systems and methods for verifying correct execution of emulated code through dynamic code caching, transformation, and state verification.

### BACKGROUND OF THE INVENTION

Operating system software and user application software are written to execute on a given type of computer system. That is, software is written to correspond to the particular instruction set in a computer system, i.e., the set of instructions that the system recognizes and that the system can execute. If the software is executed on a computer system without an operating system, the software must also be written to correspond to the particular set of components and/or peripherals in the computing system.

Computer hardware (e.g., microprocessors) and their instruction sets are often upgraded and modified, typically to provide improved performance. Unfortunately, as computer hardware is upgraded or replaced, preexisting software, which often is created at substantial cost and effort, is rendered obsolete. Specifically, software written for an instruction set corresponding with the original hardware often contains instructions that a new host hardware platform does not understand.

Various solutions are currently used to deal with the aforementioned difficulty. One such solution is to maintain obsolete computer hardware instead of replacing it with the upgraded hardware. This alternative is unattractive for several reasons. First, a great deal of expense and effort is required to maintain such outdated hardware. Second, where the new hardware is more powerful, failing to replace the outdated hardware equates to foregoing potentially significant performance improvements for the computer system.

A further solution to the problem, and perhaps most common, is to modify and/or replace all of the software each time the underlying hardware is replaced. This solution is equally unattractive, however, in view of the expense and effort required to modify and/or replace each software application. In addition to the expense and effort associated with modifying and/or replacing software enterprises may encounter inefficiencies that result from the learning curve associated with training the users of the software.

Another potential solution to the problem is to provide a virtual machine environment in which the original software can be executed on a new host system. This solution has the advantage of neither requiring maintenance of outdated hardware nor complete replacement of the original software. Unfortunately, however, present emulation systems lack the resources to provide a hardware emulation for real-world software applications due to the complexity associated with emulating each action of the original hardware. For example, to emulate a computer system for an actual program such as an operating system, the emulation system must be able to handle asynchronous events that may occur such as exceptions and interrupts. Furthermore, present emulation systems lack an efficient mechanism for verifying that translated code is operative in the manner intended by the original system.

From the foregoing, it can be appreciated that it would be desirable to have systems and methods for emulating a computer system that avoids one or more of the above-noted problems while providing a mechanism for verifying translated code.

### SUMMARY

The present disclosure generally relates to systems and methods for verifying correctness of the execution of translated code operative on a computer system. In one arrangement, the system compares the state of an emulated computer system during the execution of a given program, where the state of the emulation is generated in two different ways, one method fetches the program code originally meant to be executed on a different computer system, translates the program code for a target computer system, emits translated program code into at least one code cache, executes the translated code within the at least one code cache, thus altering a first emulated state; the second method (the reference model) interprets the same program code to generate a second emulated state.

The present disclosure also relates to a system for verifying execution of translated code that was written for an original computer system on a different host computer system. In one arrangement, the system comprises an interpreter, a translator, a virtual machine that comprises a dynamic execution-layer interface including a core having at least one code cache in which code fragments can be cached and executed, and an application-programming interface that links the translator to the virtual machine.

### BRIEF DESCRIPTION OF THE DRAWINGS

The invention can be better understood with reference to the following drawings.

FIG. 1 is a block diagram illustrating an embodiment of a system that is configured to provide a virtual machine environment for software to be executed on a host computer system.

FIG. 2 is a flow diagram that illustrates operation of the system of FIG. 1.

FIG. 3 is a block diagram illustrating an embodiment of a dynamic execution-layer interface (DELI) as used in the system of FIG. 1.

FIG. 4 is a block diagram illustrating operation of the core of the DELI shown in FIG. 3.

FIG. 5 is a block diagram of an embodiment of a host computer system on which the system shown in FIG. 1 can be operated.

FIG. 6 is a block diagram illustrating the operation of a translated code verification that may be performed on the system of FIG. 1.

FIG. 7 is a flow diagram that illustrates a method for verifying translated code that may be integrated with the flow diagram of FIG. 2.

### DETAILED DESCRIPTION

Disclosed and invented are systems and methods for verifying the accuracy and execution of translated code originally written for a computer system different from that of a host computer system. The systems and methods perform state verifications at a plurality of synchronization points in translated and cached code. The emulated state generated within a translator is compared to a state generated by a previously verified interpreter to identify flaws (i.e., bugs) in the translated code. When the states do not match, a sequencer associated with the translator and in communication with the interpreter reports a translated code discrepancy to an application-programming interface (API) manager. Otherwise, the translated code portion (to the synchronization point) is confirmed and code translation/execution may continue.

In accordance with one embodiment, when the states do not match the virtual machine may be configured to set a debug sensitivity level, load the last successfully verified state, and reset both the interpreter and the translator in preparation to repeat executable steps from the point where the translated code was last confirmed. The API manager may be configured to increase the debug sensitivity level such that state comparisons are performed at intervals other than those defined by the translated code synchronization points in order to ultimately identify the location of a flaw in the translated code.

In alternative embodiments, when the states fail to match, the virtual machine may be configured to interface with an application program configured to permit operator directed state comparisons.

As explained below, emulation of the original computer system is facilitated with a dynamic execution-layer interface (DELI) that is utilized via the API manager. To facilitate description of the inventive systems and methods, exemplar systems and methods are discussed with reference to the figures. Although these examples are described in detail, it will be appreciated that they are provided for purposes of illustration only and that various modifications are feasible without departing from the concepts disclosed. After the description of the systems, examples of operation of the systems are provided to explain the manners in which system emulation can be facilitated.

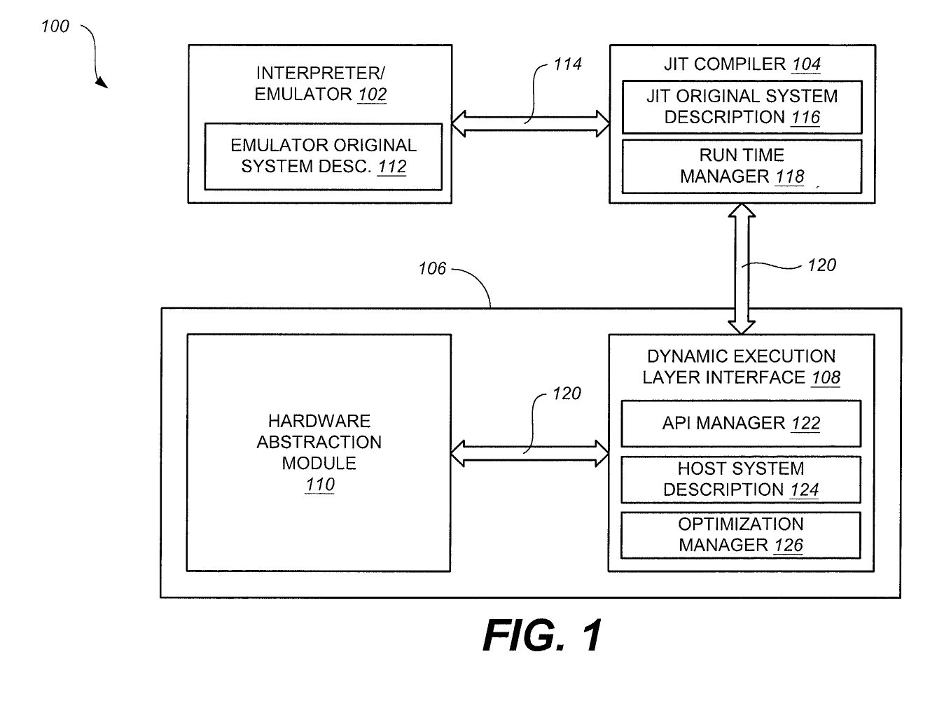

FIG. 1 presents a simplified emulation system 100 that is capable of providing a virtual machine environment in which software can be executed. As indicated in this figure, the system 100 generally comprises an interpreter/emulator 102, a just-in-time (JIT) compiler 104, and a virtual machine 106 that can include a dynamic execution-layer interface (DELI) 108 and a hardware abstraction module (HAM) 110. Generally, the interpreter/emulator 102 emulates the hardware of the original computer system for which the software (e.g., a program) running on the system 100 was written. Accordingly, the interpreter/emulator 102, from the perspective of a program executed by the system 100, performs all of the actions of that the original hardware would have performed during native execution of the program.

As is suggested by its name, the interpreter/emulator 102 implements an interpreter to provide emulation of the original computer system. As is generally known to persons having ordinary skill in the art, interpreters receive code, interpret it by determining the underlying semantics associated with the code, and carry out the semantic actions. As shown in FIG. 1, the interpreter/emulator 102 normally comprises an original system description 112 that includes information about the instruction set of the original system hardware (i.e., the system being emulated) that is needed to properly emulate the original system. Although an interpreter/emulator is explicitly identified in the figure and described herein, it is to be understood that, more generally, an emulation functionality is being provided. Accordingly, the interpreter/emulator 102 could comprise a different type of emulator, such as a translator/emulator. Furthermore, it is to be appreciated that an emulator need not be provided at all where the JIT compiler 104 (described below) is capable of providing this functionality.

The interpreter/emulator 102 is linked to the JIT compiler 104 with an interface 114. As its name suggests, the JIT compiler 104 is configured to provide run time compilation (i.e., translation) of software. More particularly, the JIT compiler 104 provides binary translation of the program to be executed. In operation, the JIT compiler 104 receives a representation of the program and translates it into an equivalent program (i.e., one having the same semantic functionality) for the target hardware of the host computer system. Similar to the interpreter/emulator 102, the JIT compiler 104 comprises a system description 116 that comprises information about the instruction set of the original system hardware. The system description 116, however, comprises the information the JIT compiler 104 needs to properly translate code into the desired form. In addition to the system description 116, the JIT compiler 104 comprises a run time manager 118 that permits the DELI 108 to invoke callback methods into the JIT compiler 104 to, for instance, notify the JIT compiler 104 as to the occurrence of certain events. When such callback methods are invoked, the run time manager 118 may be used to implement the callback methods.

The JIT compiler 104 is linked to the virtual machine 106 via an application-programming interface (API) 120. This API 120 facilitates communications between the JIT compiler 104 and the virtual machine 106 and, more specifically, the DELI 108. Accordingly, the API 120 can be used by the JIT compiler 104 to access, for instance, code caching and linking services of the DELI 108 and can be used by the DELI to invoke the callback methods into the JIT compiler 104. As is further indicated in FIG. 1, the DELI 108 can comprise an application-programming interface (API) manager 122, a host system description 124, and an optimization manager 126. The host system description 124 comprises the information that the DELI 108 needs about the host computer system such as its hardware, instruction set, etc. Operation of the API manager 122 and the optimization manager 126 is described in detail below.

In addition to the DELI 108, the virtual machine 106 also can include the HAM 110. In that the details of the configuration and operation of the HAM 110 are not specifically relevant to the present disclosure, a detailed description of the HAM is not provided herein. However, it suffices to say that the HAM 110 is generally configured to manage the hardware-related events (e.g., interrupts) of the original computer system that are to be emulated on the host computer system. The services of the HAM 110 can be utilized by the DELI 108 via the API 120 which, as indicated in FIG. 1, also links the DELI 108 to the HAM 110. Consequently, the DELI 108 can be arranged to act as a controller that can suspend the execution of a software program or otherwise handle asynchronous events.

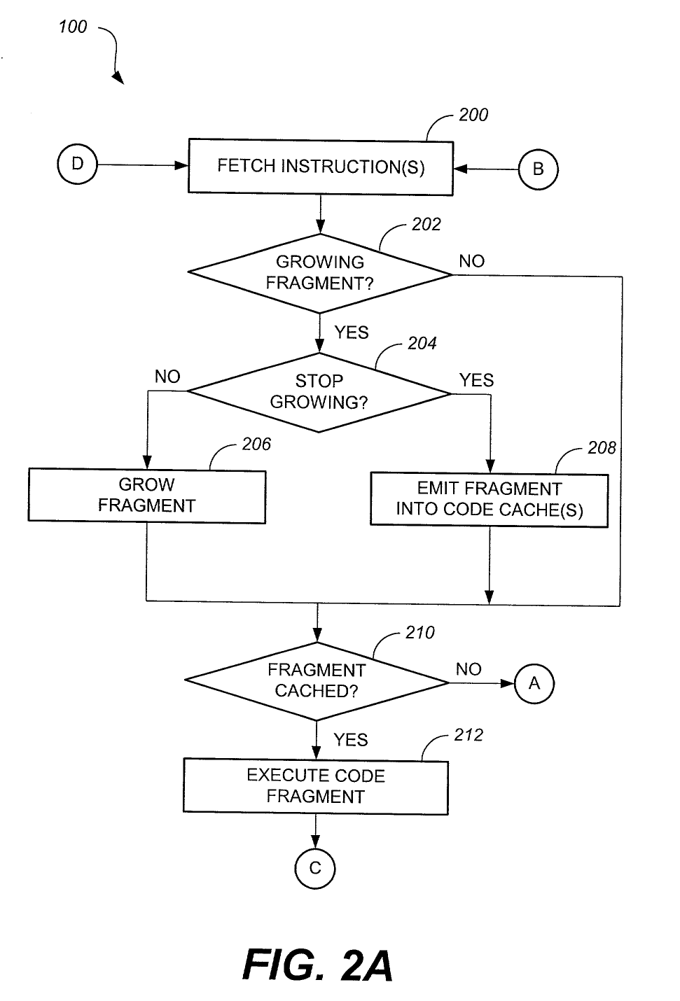

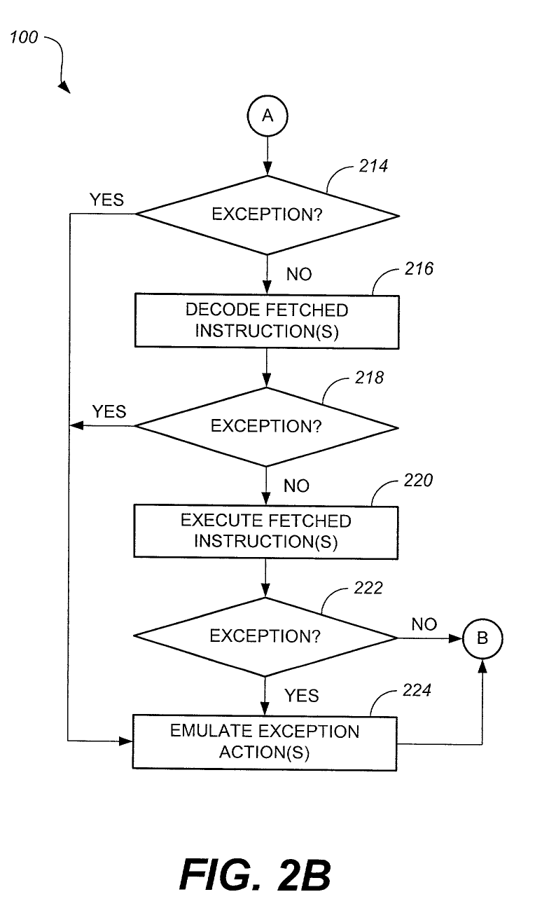

The general construction of the system 100 having been provided above, an example of operation of the system will now be provided in relation to the flow diagram presented in FIGS. 2A and 2B. Beginning with block 200 of FIG. 2A, one or more program instructions are fetched from memory by the interpreter/emulator 102. In the emulation context, this comprises accessing the original memory address from the original computer system and using it to identify the actual location of the instruction(s) on the host computer system. Once the instruction(s) have been fetched, flow is continued by the JIT compiler 104.

With reference to decision element 202, the JIT compiler 104 first determines whether the system 100 is currently growing a code fragment by linking various program instructions together. As is known in the art, such linking is typically performed to increase execution efficiency of the code. If the system is not currently growing a code fragment, for instance a machine state exists in which the JIT compiler 104 is not able to grow a fragment, flow continues to decision element 210 described below. If, on the other hand, the system 100 is growing a code fragment, flow continues to decision element 204 at which the JIT compiler 104 determines whether to continue growing the code fragment (by adding the fetched instruction(s) to the fragment) or stop growing the code fragment. This determination is made in view of certain internal criteria. For example, the JIT compiler 104 can be configured to grow a fragment until a section of code containing a branch (i.e., control flow instructions) is obtained.

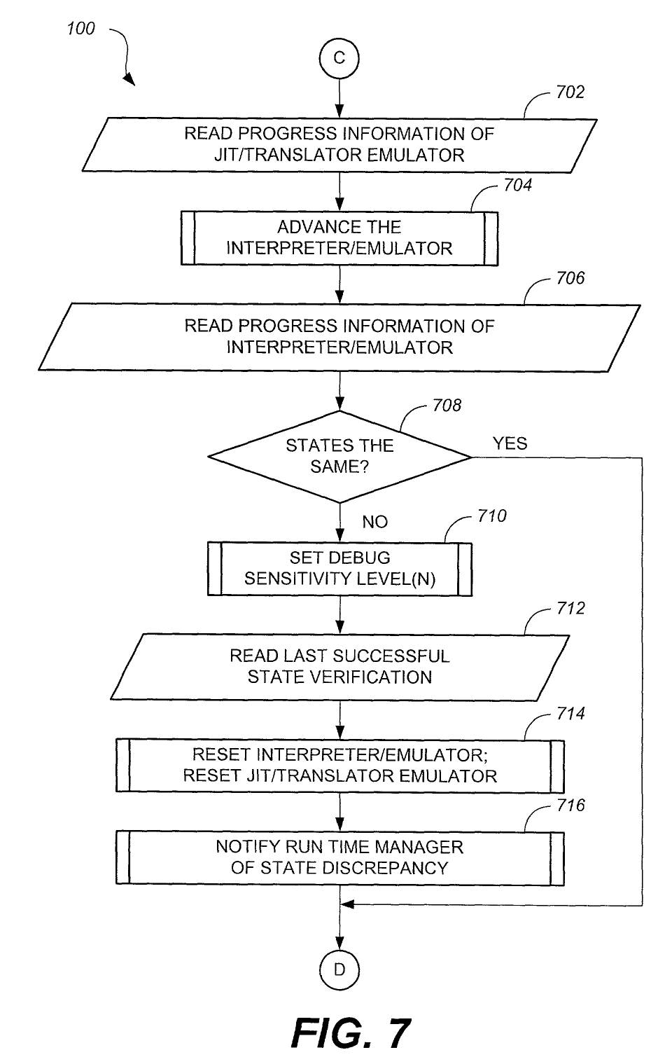

If the JIT compiler 104 determines not to stop growing the fragment (i.e., to continue growing the fragment), flow continues to block 206 at which the fragment is grown, i.e. where the fetched program instruction(s) is/are added to the fragment that is being grown. If the JIT compiler 104 determines to stop growing the fragment, however, flow continues to block 208 at which a translation for the existing code fragment is emitted into a code cache of the DELI 108 via the API 120. A detailed discussion of the manner in which such code fragments can be emitted to the DELI 108 is provided below. As is explained in that description, once the code fragment has been cached in the DELI 108, it can be executed natively from the DELI code cache(s) when the semantic function of the original code is required. Such operation permits greatly improved efficiency in executing the program on the host computer in that the overhead associated with translating the original code is avoided the next time the semantic function is required. In addition to emitting code fragment to the code cache(s), the JIT compiler 104 associates the original instruction(s) with the emitted fragment with an identifier such as a tag so that the JIT compiler 104 will know that a translation for the original program instruction(s) already resides in the code cache(s) of the DELI 108. Once the code has been cached, it can be executed and later verified by the method illustrated and described in the flow diagram of FIG. 7. This verification occurs before the code in the code cache is linked according to various policies provided to the DELI 108.

As illustrated in the flow diagram of FIG. 2A, irrespective of whether fragment growth is contemplated or whether it was previously determined not to grow the present code fragment, the JIT compiler 104 continues to decision element 210 at which the JIT compiler 104 determines whether a translation of the fetched instruction(s) has been cached, i.e. is contained within a code cache of the DELI 108. If so, execution then jumps to the code cache(s) of the DELI 108 and the translated code fragment is executed natively, as indicated in block 212. Execution continues in the code cache(s) until such time when a reference to code not contained therein (e.g., a cache miss) is encountered and/or the execution has reached a synchronization point (e.g., an execution flow control command). When a cache miss is encountered, flow returns to block 200 and the next program instruction(s) is/are fetched. Otherwise, when the execution encounters a synchronization point, the DELI 108 may be temporarily halted while a client (i.e., a translator/emulator or other application) takes temporary control to verify or otherwise coordinate the emulation. This second possibility is further illustrated and described with regard to the flow diagram of FIG. 7. Connectors labeled “C” and “D” shown in FIGS. 2A and 7 relate the flow diagrams.

Returning to decision element 210 of FIG. 2A, if a translation of the fetched instruction(s) has not been cached, flow returns to the interpreter/emulator 102, which is illustrated in FIG. 2B. Beginning with decision element 214 of this figure, the interpreter/emulator 102 determines whether the instruction fetching action that was conducted in block 200 would have created an exception in the original computer system being emulated. By way of example, such an exception could have arisen where there was no permission to access the portion of memory at which the instruction(s) would have been located. This determination is made with reference to the information contained within the system description 112. If such an exception would have occurred, flow continues down to block 224 at which the exception action or actions that would have been taken by the original computer system is/are emulated by the interpreter/emulator 102 for the benefit of the program.

Assuming no exception arose at decision element 214, flow continues to block 216 at which the fetched instruction(s) is/are decoded by the interpreter/emulator 102. Generally, this action comprises interpreting the nature of the instruction(s), i.e., the underlying semantics of the instruction(s). Next, with reference to decision element 218, it can again be determined whether an exception would have occurred in the original computer system. Specifically, it is determined whether the instruction(s) would have been illegal in the original system. If so, flow continues to block 224 and the exception action(s) that would have been taken by the original computer system are emulated. If not, flow continues to block 220 at which the semantics of the fetched instruction(s) are executed by the interpreter/emulator 102 to emulate actual execution of the instruction(s) by the original computer system. At this point, with reference to decision element 222, it can again be determined whether an exception would have arisen in the original computer system. In particular, it can be determined whether it would have been illegal to execute the instruction(s) in the original system. If an exception would have arisen, flow continues to block 224. If no exception would have arisen, however, flow returns to block 200 and one or more new program instructions are fetched.

Notably, in the initial stages of operation of the system 100, i.e. when emulation is first provided for the program, most execution is conducted by the interpreter/emulator 102 in that little or no code resides within (i.e., has been emitted into) the code cache(s) of the DELI 108. However, in a relatively short amount of time, most if not all execution is conducted within the code cache(s) of the DELI 108 due to the emitting step (block 208). By natively executing code within the code cache(s), the overhead associated with interpreting and emulating is avoided (in that these steps have been previously performed and have generated identifiable results that can be stored in memory), thereby greatly increasing emulation efficiency.

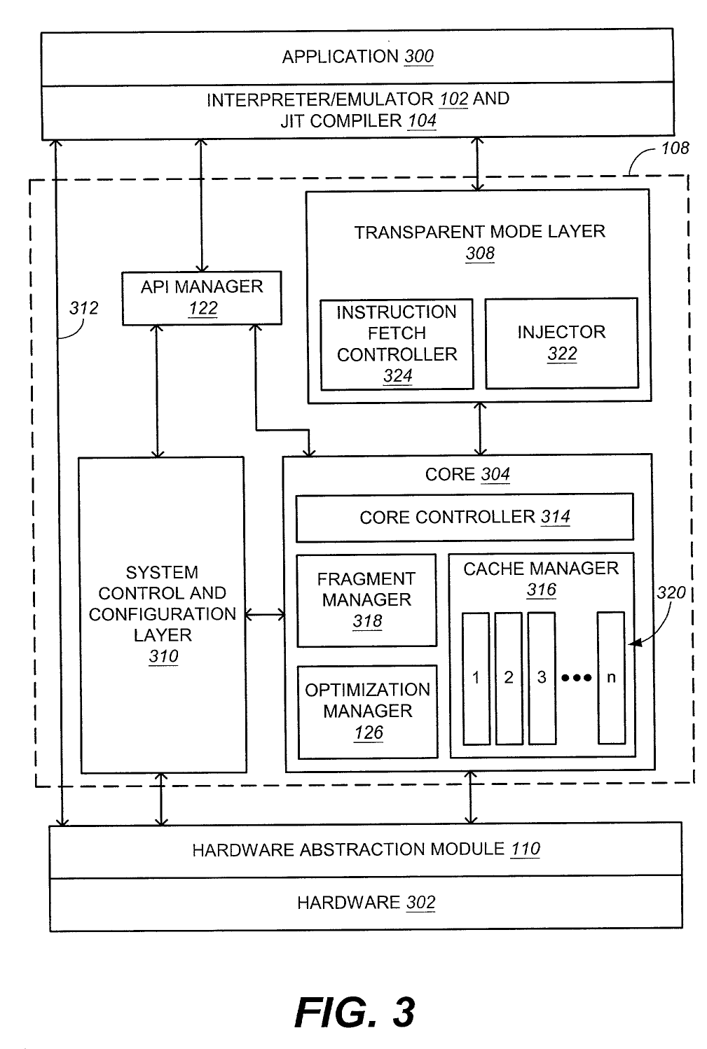

As identified above in relation to FIGS. 1 and 2, emulation efficiency is significantly increased due to the introduction of the DELI 108. FIG. 3 illustrates an exemplar configuration for the DELI 108. Generally, the DELI 108 comprises a generic software layer written in a high or low-level language that resides between applications, including or not including an operating system (O/S), and hardware to untie application binary code from the hardware. Through this arrangement, the DELI 108 can provide dynamic computer program code transformation, caching, and linking services which can be used in a wide variety of different applications such as emulation, dynamic translation and optimization, transparent remote code execution, remapping of computer system functionality for virtualized hardware environments program, code decompression, code decrypting, translated code verification, etc.

Generally, the DELI 108 can provide its services while operating in a transparent mode, a nontransparent mode, or combinations of the two. In the transparent mode, the DELI 108 automatically takes control of an executing program in a manner in which the executing program is unaware that it is not executing directly on computer hardware. In the nontransparent mode, the DELI 108 exports its services through the API 120 to the application 300 (e.g., a client) to allow the application 300 to control how the DELI 108 reacts to certain system events.

As depicted in FIG. 3, the DELI 108 resides between at least one application (i.e., a program or set of executable instructions) 300 and computer hardware 302 of the host computing system. In that the application 300 was written for the original computer system that is being emulated, the application 300 is unaware of the DELI's presence. Underneath the application 300 resides a client that in this case, comprises the interpreter/emulator 102 and the JIT compiler 104. Unlike the application 300, the client is aware of the DELI 108 and is configured to utilize its services.

The DELI 108 can include four main components including a core 304, an API manager 122, a transparent mode layer 308, and a system control and configuration layer 310. Generally, the core 304 exports two primary services to both the API manager 122 (and therefore to the API 120) and the transparent mode layer 308. The first of these services pertains to the caching and linking of native code fragments or code fragments, which correspond to the instruction set of the hardware 302. The second pertains to executing previously cached code fragments. The API manager 122 exports functions to the client (e.g., the JIT compiler 104) that provide access to the caching and linking services of the core 304 in the nontransparent mode of operation. The transparent mode layer 308, where provided, enables the core 304 to gain control transparently over code execution in the transparent mode of operation, as well as fetch code fragments to be cached. Finally, the system control and configuration layer 310 enables configuration of the DELI 108 by providing policies for operation of the core 304 including, for example, policies for the caching, linking, and optimizing of code. These policies can, for example, be provided to the layer 310 from the client via the API manager 122. The system control and configuration layer 310 also controls whether the transparent mode of the DELI 108 is enabled, thus determining whether the core 304 receives input from the API manager 122, the transparent mode layer 308, or both. As is further indicated in FIG. 3, the system 306 can include a bypass path 312 that can be used by the application 300 to bypass the DELI 108 so that the application can execute directly on the hardware 302, where desired.

As is shown in FIG. 3, the core 304 comprises a core controller 314, a cache manager 316, a fragment manager 318, and the optimization manager 126 first identified in FIG. 1. The core controller 314 functions as a dispatcher that assigns tasks to the other components of the core 304 that are responsible for completing the tasks. The cache manager 316 comprises a mechanism (e.g., set of algorithms) that controls the caching of the code fragments within one or more code caches 320 (e.g., caches 1 through n) according to the policies specified by the system control and configuration layer 310, as well as the fragment manager 318 and the optimization manager 126. The one or more code caches 320 of the core 304 can, for instance, be located in specialized memory devices of the hardware 302, or can be created in the main local memory of the hardware. Where the code cache(s) 320 is/are mapped in specialized memory devices, greatly increased performance can be obtained due to reduced instruction cache refill overhead, increased memory bandwidth, etc. The fragment manager 318 specifies the arrangement of the code fragments within the code cache(s) 320 and the type of transformation that is imposed upon the fragments. Finally, the optimization manager 126 contains the set of optimizations that can be applied to the code fragments to optimize their execution.

As noted above, the API manager 122 exports functions to the application 300 thus providing access to DELI services. More specifically, the API manager 122 exports caching and linking services of the core 304 to the client (e.g., JIT compiler 104) via the API 120. These exported services enable the client to control the operation of the DELI 108 in the nontransparent mode by, for example, explicitly emitting code fragments to the core 304 for caching and instructing the DELI 108 to execute specific code fragments out of its code cache(s) 320. In addition, the API manager 122 also can export functions that initialize and discontinue operation of the DELI 108. For instance, the API manager 122 can initiate transparent operation of the DELI 108 and further indicate when the DELI 108 is to cease such operation. Furthermore, the API manager 122 also, as mentioned above, facilitates configuration of the DELI 108 by delivering policies specified by the client to the core 304 (e.g., to the fragment manager 318 and/or to the optimization manager 126).

With further reference to FIG. 3, the transparent mode layer 308 can include an injector 322 that can be used to gain control over an application transparently. When the DELI 108 operates in a completely transparent mode, the injector 322 is used to inject the DELI 108 into the application 300 before the application begins execution so that the application can be run under DELI control. Control can be gained by the injector 322 in several different methods, each of which loads the application binaries without changing the virtual address at which the binaries are loaded. Examples of these methods are described in U.S. patent application Ser. No. 09/924,260, filed Aug. 8, 2001, entitled, “Dynamic Execution-Layer Interface for Explicitly or Transparently Executing Application or System Binaries” (attorney docket no. 10011525-1), which is hereby incorporated by reference into the present disclosure. In the emulation context, however, such completely transparent operation is typically not used in that the client is configured to use the DELI's services in an explicit manner.

As noted above, the system control and configuration layer 310 enables configuration of the DELI 108 by providing policies for various actions such as the caching and linking of code. More generally, the policies typically determine how the DELI 108 will behave. For instance, the layer 310 may provide policies as to how fragments of code are extracted from an application, how fragments are created from the original code, how multiple code fragments can be linked together to form larger code fragments, etc. The layer's policies can be static or dynamic. In the former case, the policies can be hardcoded into the DELI 108, fixing the configuration at build time. In the latter case, the policies can be dynamically provided by the client through function calls in the API 120. Implementation of the policies can control the manner in which the DELI 108 reacts to specific system and/or hardware events (e.g., exceptions and interrupts). In addition to the policies noted above, the system control and configuration layer 310 can specify the size of the code cache(s) 320, whether a log file is created, whether code fragments should be optimized, etc.

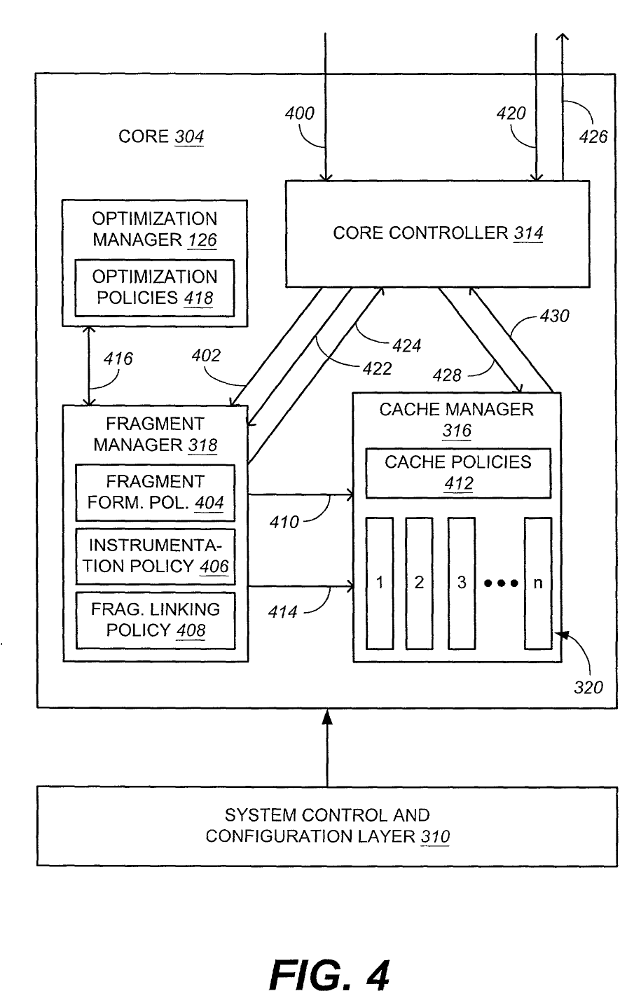

FIG. 4 illustrates an example configuration of the core 304 and its operation. As indicated in the figure, the core 304 accepts two primary types of requests from the API manager 122 or the transparent-mode layer 308. First, requests can be accepted for caching and linking a code fragment through a function interface 400. In its most basic form, such a request can comprise a function in the form of, for instance, “Deli_emit_fragment(tag),” which receives a code fragment as its parameters and an identifier (e.g., a tag) to store in the DELI cache(s) 320. In another example, the core 304 can accept requests for initiating execution at a specific code fragment tag through a function interface such as “Deli_exec_fragment(tag),” which identifies a code fragment stored in the cache(s) 320 to pass to the hardware 302 for execution.

The core controller 314 processes these requests and dispatches them to the appropriate core module. A request 402 to emit a code fragment with a given identifier can then be passed to the fragment manager 318. The fragment manager 318 transforms the code fragment according to its fragment formation policy 404, possibly instruments the code fragment according to its instrumentation policy 406, and links the code fragment together with previously cached fragments according to its fragment linking policy 408. For example, the fragment manager 318 may link multiple code fragments in the cache(s) 320, so that execution jumps to another code fragment at the end of executing a code fragment, thereby increasing the length of execution from the cache(s). To accomplish this, the fragment manager 318 issues fragment allocation instructions 410 to the cache manager 316. The fragment manager 318 then sends a request to the cache manager 316 to allocate the processed code fragment in the code cache(s) 320.

The cache manager 316 controls the allocation of the code fragments and typically is equipped with its own cache policies 412 for managing the cache space. However, the fragment manager 318 may also issue specific fragment deallocation instructions 414 to the cache manager 316. For example, the fragment manager 318 may decide to integrate the current fragment with a previously allocated fragment, in which case the previous fragment may need to be deallocated. In some arrangements, the cache manager 316 and fragment manager 318 can manage the code cache(s) 320 and code fragments in the manner shown and described in U.S. Pat. No. 6,237,065, issued May 22, 2001, entitled “A Preemptive Replacement Strategy for a Caching Dynamic Translator Based on Changes in the Translation Rate,” which is hereby incorporated by reference into the present disclosure. Alternatively, management of the code cache(s) 320 and code fragments may be performed in the manner shown and described in U.S. patent application Ser. No. 09/755,389, filed Jan. 5, 2001, entitled, “A Partitioned Code Cache Organization to Exploit Program Locality,” which is also hereby incorporated by reference into the present disclosure.

Prior to passing a fragment to the cache manager 316, the fragment manager 318 may pass the fragment to the optimization manager 126 via interface 416 to improve the quality of the code fragment according to its optimization policies 418. In some arrangements, the optimization manager 126 may optimize code fragments in the manner shown and described in U.S. patent application Se. No. 09/755,381, filed Jan. 5, 2001, entitled, “A Fast Runtime Scheme for Removing Dead Code Across Linked Fragments,” which is hereby incorporated by reference into the present disclosure. Alternatively, the optimization manager 126 may optimize code fragments in the manner shown and described in U.S. patent application Ser. No. 09/755,774, filed Jan. 5, 2001, entitled, “A Memory Disambiguation Scheme for Partially Redundant Load Removal,” which is also hereby incorporated by reference into the present disclosure. Notably, the optimization manager 126 may also optimize code fragments using classical compiler optimization techniques, such as elimination of redundant computations, elimination of redundant memory accesses, inlining functions to remove procedure call/return overhead, dead code removal, implementation of peepholes, etc. Typically, the optimization manager 126 deals with intermediate representations (IRs) of the code that is to be optimized. In such an arrangement, the client may be aware that IR code is needed and can call upon the API 120 to translate code from native to an IR for purposes of optimization, and back again to native, once the optimization(s) has been performed.

As mentioned above, the fragment manager 318 transforms the code fragment according to its fragment formation policy 404. The transformations performed by the fragment manager 318 can include code relocation by, for instance, changing memory address references by modifying relative addresses, branch addresses, etc. The layout of code fragments may also be modified, changing the physical layout of the code without changing its functionality (i.e., semantics). These transformations are performed by the fragment manager 318 on fragments received through the API 120 and from the instruction fetch controller 324 of the transparent mode layer 308.

As identified above, the other primary type of request accepted by the DELI core 304 is a request 420 to execute a fragment identified by a given identifier (e.g., tag). In such a case, the core controller 314 issues a lookup request 422 to the fragment manager 318, which returns a corresponding code cache address 424 if the fragment is currently resident and active in the cache(s) 320. By way of example, the fragment manager 318 can maintain a lookup table of resident and active code fragments in which a tag can be used to identify the location of a code fragment. Alternatively, the fragment manager 318 or cache manager 316 can use any other suitable technique for tracking resident and active code fragments.

When a code fragment of interest is not currently resident and active in the cache(s) 320, the fragment manager 318 returns an error code to the core controller 314, which returns the fragment tag back to the initial requester via core interface 426 as a cache miss address. If, on the other hand, the fragment is currently resident and active, the core controller 314 then patches the initial request to the cache manager 316 via controller interface 428 along with its cache address. The cache manager 316, in turn, transfers control to the addressed code fragment in its code cache(s) 320, thus executing the addressed code fragment. Execution then remains focused in the code cache(s) 320 until a cache miss occurs, i.e., until a copy for the next application address to be executed is not currently resident in the cache(s). This condition can be detected, for instance, by an attempt of the code being executed to escape from the code cache(s) 320. A cache miss is reported via interface 430 from the cache manager 316 to the core controller 314 and, in turn, via core interface 426 back to the initial requester.

Although two primary requests have been identified above in relation to FIG. 4 (i.e., emitting and executing), it is to be understood that many other types of requests may be made, particularly when emulating a computer system. Examples of other requests (functions) are described in U.S. patent application Ser. No. 09/997,163, filed Nov. 29, 2001, entitled, “System and Method for Supporting Emulation of a Computer System Through Dynamic Code Caching and Transformation,” the contents of which are incorporated herein by reference.

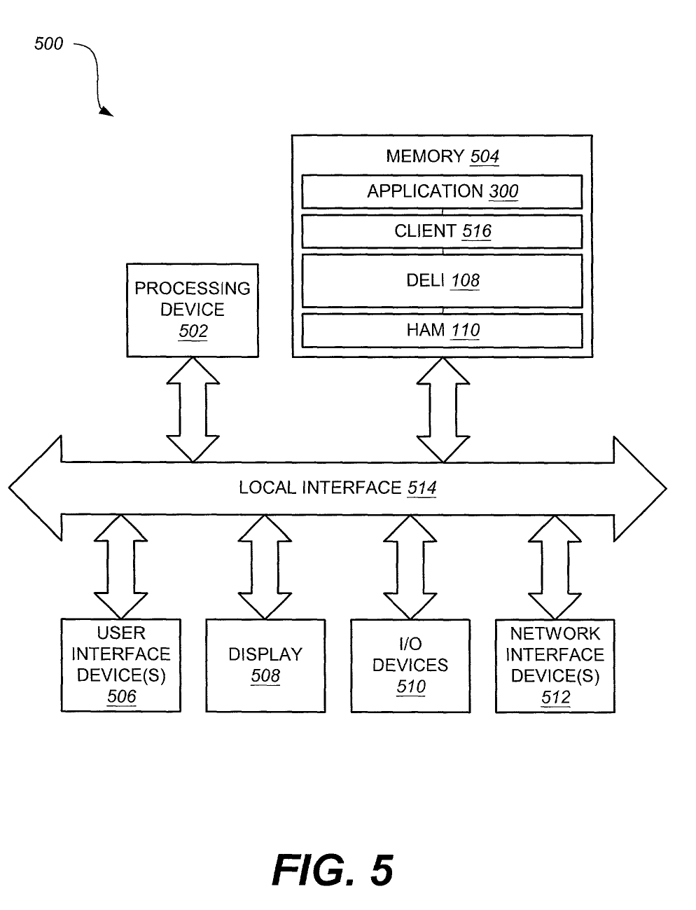

FIG. 5 is a block diagram illustrating an exemplar embodiment of a host computer system 500 on which the system 100 can be executed. Generally, the computer system 500 can comprise any one of a wide variety of wired and/or wireless computing devices, such as a desktop computer, portable computer, a dedicated server computer, a multi-processor computing device, a personal digital assistant (PDA), a handheld or pen-based computer, and so forth. Irrespective its specific arrangement, the computer system 500 can, for instance, comprise a processing device 502, memory 504, one or more user-interface devices 506, a display 508, one or more input/output (I/O) devices 510, and one or more network-interface devices 512, each of which is connected to a local interface 514.

The processing device 502 can include any custom made or commercially available processor, a central processing unit (CPU) or an auxiliary processor among several processors associated with the computer system 500, a semiconductor based microprocessor (in the form of a microchip), a macroprocessor, one or more application-specific integrated circuits (ASICs), a plurality of suitably configured digital-logic gates, and other well known electrical configurations comprising discrete elements both individually and in various combinations to coordinate the overall operation of the computing system.

The memory 504 can include any one of a combination of volatile memory elements (e.g., random-access memory (RAM, such as DRAM, SRAM, etc.)) and nonvolatile memory elements (e.g., a read-only memory (ROM), a hard drive, a tape, a compact-disc read-only memory (CDROM), etc.). The memory 504 typically comprises the application 300, the client 516, the DELI 108, and the HAM 110, each of which has already been described above. Persons having ordinary skill in the art will appreciate that the memory 504 can, and typically will, comprise other components omitted for purposes of brevity.

The one or more user-interface devices 506 comprise those components with which the user can interact with the computing system 500. For example, where the computing system 500 comprises a personal computer (PC), these components can comprise a keyboard and mouse. Where the computing system 500 comprises a handheld device (e.g., a PDA), these components can comprise function keys or buttons, a touch-sensitive screen, a stylus, etc. The display 508 can comprise a computer monitor or plasma screen for a PC or a liquid-crystal display (LCD) for a handheld device.

With further reference to FIG. 5, the one or more I/O devices 510 are adapted to facilitate connection of the computing system 500 to another system and/or device and may therefore include one or more serial, parallel, small computer system interface (SCSI), universal serial bus (USB), IEEE 1394 (e.g., Firewire™), and/or personal area network (PAN) components. The network-interface devices 512 comprise the various components used to transmit and/or receive data over a network. By way of example, the network-interface devices 512 include a device that can communicate both inputs and outputs, for instance, a modulator/demodulator (e.g., modem), wireless (e.g., radio frequency (RF)) transceiver, a telephonic interface, a bridge, a router, network card, etc.

Various software and/or firmware has been described herein. It is to be understood that this software and/or firmware can be stored on any computer-readable medium for use by or in connection with any computer-related system or method. In the context of this document, a computer-readable medium denotes an electronic, magnetic, optical, or other physical device or means that can contain or store a computer program for use by or in connection with a computer-related system or method. These programs can be embodied in any computer-readable medium for use by or in connection with an instruction-execution system, apparatus, or device, such as a computer-based system, processor-containing system, or other system that can fetch the instructions from the instruction-execution system, apparatus, or device and execute the instructions. In the context of this document, a “computer-readable medium” can be any means that can store, communicate, propagate, or transport the program for use by or in connection with the instruction-execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random-access memory (RAM), a read-only memory (ROM), an erasable-programmable read-only memory (EPROM, an electrically-erasable programmable read-only memory (EEPROM), or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

As identified above, emulation of the original computer system is facilitated in large part due to the functionality provided by the API 120. In a trivial context, the API 120 would only need to enable emission of code fragments to the DELI code cache(s) 320 and submit requests to execute these fragments in the manner described above in relation to FIG. 4. Where binary translation is to be provided for a real-world program such as an O/S, however, the API 120 must provide the additional functionality to deal with asynchronous events such as exceptions and interrupts, as well as other complications that result from emulating all the aspects of the original computer system hardware. Therefore, a “smarter” interface is needed to provide a practical emulation system. The particular design of the hardware being emulated and the capabilities of the computing system 500 will dictate the structure and operation of this “smarter” interface.

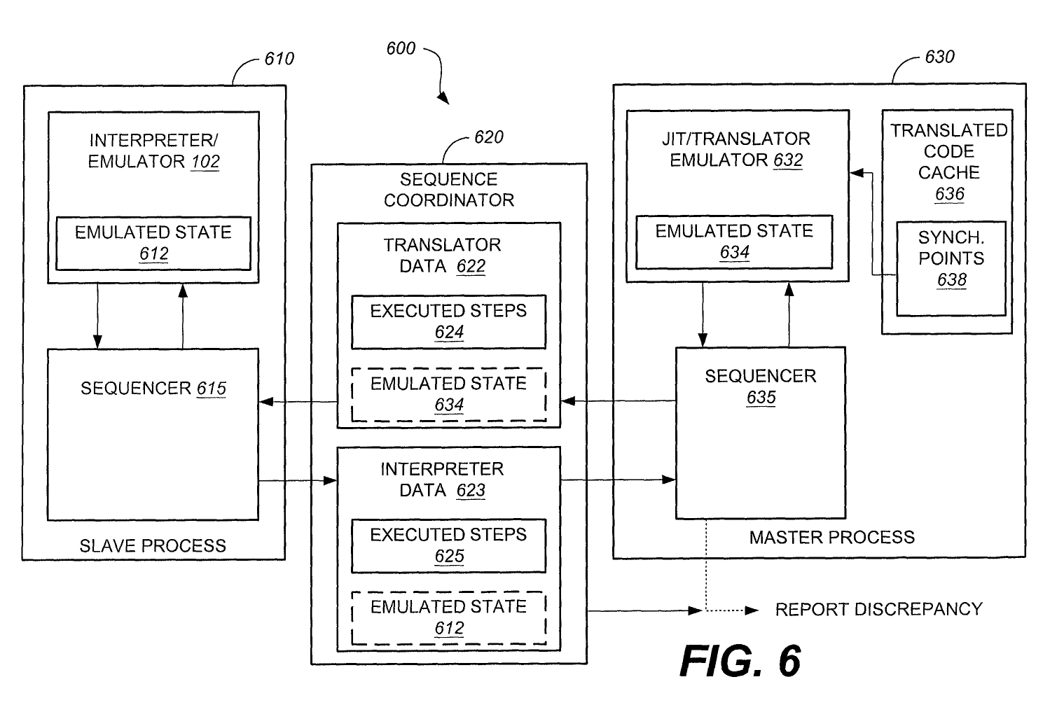

FIG. 6 presents a block diagram illustrating the operation of a master-slave process within a virtual system that can verify correct operation of translated code that may be implemented by the emulation system 100 of FIG. 1. When a JIT/translator emulator that caches translated code to interpret the code for an existing instruction set architecture (e.g., an advanced RISC machine (ARM), SuperH, etc.) or for when a virtual machine like JAVA is used, it is desirable to debug and verify the correct execution of the translated code being emulated in the context of the translated code cache. Note, JAVA is not an acronym. JAVA is a general purpose, high-level, object-oriented, cross platform programming language.

In this regard, a virtual system 600 may include a slave process 610, a sequence coordinator 620, and a master process 630. As explained in further detail below, it is possible to execute and monitor two emulation processes of original code for the same instruction set architecture (ISA), an interpreter/emulator 102, and a JIT/translator emulator 632 in a master-slave relationship. The JIT/translator emulator 632 acts as the master and the interpreter/emulator 102 acts as the slave.

As illustrated in FIG. 6, the master process 630 includes the JIT/translator emulator 632, a sequencer 635, and a translated code cache 636. The master process 630 identifies synchronization points 638 in the translated and cached code (i.e., within cached code in the translated code cache 636) and interrupts execution of the JIT/translator emulator 632 when a synchronization point 638 is encountered during code translation. Sequencer 635 receives translator data 622 from the JIT/translator emulator 632 and forwards the translator data 622 to the sequence coordinator 620.

The sequence coordinator 620 accepts and forwards translator data 622 from the JIT/translator emulator 632 to the slave process 610. The sequence coordinator 620 is also configured to accept and forward interpreter data 623 generated by the interpreter/emulator 102 that is designated for the master process 630.

As shown in the diagram of FIG. 6, the slave process 610 may include the interpreter/emulator 102 and an emulator sequencer 615. The interpreter/emulator 102 has been previously verified to include code that accurately replicates the operation of software on a specified hardware platform, this is known as a much easier task to complete than the verification of a translating emulator (alternatively, the slave process 610 can be just a front end to control (e.g., the front end may be controlled through insertion of breakpoints and a remote debugger) the execution of the same program code on the actual computer system being emulated, even if this would ultimately result in a more complex system). The slave process 610 receives the translator data 622 via sequencer 615. As illustrated, translator data 622 may include an indication of the number of executable steps within the original code that have been processed by the JIT/translator emulator 632. The translator data 622 may also include information regarding the present state of the emulated machine at that point in the execution of the translated code. The translator data 622 may be used by the slave process 610 to direct the sequencer 615 to advance the interpreter/emulator 102 through the same number of executable steps in the original code.

After the sequencer 615 receives the emulated state 612 from the interpreter/emulator 102 and confirms that the slave process 610 has advanced to the same point in the original code, the sequence coordinator 620 or other suitable code may compare the emulated states 612, 634 in order to confirm correct operation of the JIT/translator emulator 632. If the states are equivalent it is assumed that the translated code has functioned as a true and accurate translation of the original code and hardware platform being emulated. When the compared states are equivalent, the sequence coordinator 620 may be configured to send a confirmation to sequencer 635 and the master process 630 may continue to translate and cache translated code until the next synchronization point 638 is encountered in the translated code cache 636. Otherwise, when the compared states are not equivalent, the sequence coordinator 620 or other suitably configured code (e.g., sequencer 635) may be configured to report the state discrepancy.

The concept of execution steps should be defined for both the interpreter/emulator 102 and the JIT/translator emulator 632 to permit a valid state comparison. A number of choices for the definition of “execution steps” are possible. For example, the number of emulated instructions can be used. In this case, both the interpreter/emulator 102 and the JIT/translator emulator 632 may contain additional machinery to keep track of the number of emulated instructions both during interpretation and during execution of the translated code, respectively. This could create additional overhead for the JIT/translator emulator 632 as the translations would contain more code and run possibly less efficiently. A possible alternative method to monitor emulated instructions is to keep track of control flow changes by storing a trace of the execution from the last synchronization point when an emulated program counter is not incremented linearly. This alternative method could be achieved by recording the sequence of program counter updates by more than a unit increment (where unit is defined as one instruction) i.e., when a branch instruction is emulated. Such a trace could store a sequence of incremental distances from the last value of the program counter to save space, and then be used by the slave process 610 to advance the interpreter/emulator 102 until the same point in the original program code is reached or a difference in the trace is detected.

The approach illustrated and described in association with the virtual system 600 of FIG. 6 permits the flexible verification of all or only a portion of the emulated states of the respective emulators (i.e., the JIT/translator emulator 632 and the interpreter/emulator 102). Furthermore, this flexibility allows an application (e.g., a debugger (not shown) to focus the verification process on critical portions of the translated execution. Moreover, the master process 630 (i.e., the JIT/translator emulator 632 can direct the performance of subsequent state comparisons at any point where the emulated state is identifiable to permit efficient emulation during the debugging process.

FIG. 7 is a flow diagram that illustrates a method for verifying translated code that may be associated with the flow diagram of FIG. 2. As illustrated in step 702, the emulation system 100 is configured to retrieve progress information regarding the translation of original code in the JIT/translator emulator 632. This progress information may include an indication of the number of executable steps in the original code that the JIT/translator emulator 632 has encountered, as well as the present state of the JIT/translator emulator 632. After having retrieved the progress information from the JIT/translator emulator 632 associated with the master process 630, the emulation system 100 may be configured to advance the interpreter/emulator 102 as indicated in step 704. After advancing the interpreter/emulator 102 by the number of encountered executable steps in the original code, the emulation system 100 may be configured to read and/or otherwise access progress information regarding the interpreter/emulator 102 as illustrated in step 706. As in step 702, the emulation system 100 retrieves data regarding the number of executable steps that the interpreter/emulator 102 has encountered, as well as the present state of the interpreter/emulator 102.

The emulation system 100, having accessed the present state of the JIT/translator emulator 632 operative in the master process 630 and the present state of the interpreter/emulator 102 operative in the slave process 610 is now prepared to perform the state comparison indicated in step 708. When it is the case that the states are the same processing may continue at the connector labeled, “D” as shown in the flow diagram of FIG. 2A. Otherwise, when it is determined that the states retrieved from the interpreter/emulator 102 and the JIT/translator emulator 632 are not the same, the emulation system 100 may be configured to set a debug sensitivity level as indicated in step 710 and read or otherwise access information identifying the last successful state verification as shown in step 712. After each confirmation comparison, the emulation system 100 may be configured to store information regarding the state of the interpreter/emulator 102 and the JIT/translator emulator 632, as well as information regarding the location in the respective code being processed.

As further illustrated in step 714, the emulation system 100 may be configured to use the previously stored information to reset both the interpreter/emulator 102 and the JIT/translator emulator 632 to the last confirmed executable step for the respective devices. As part of the reset step, the state of both the interpreter/emulator 102 and the JIT/translator emulator 632 will be returned to that observed at the designated point in the execution. As is further illustrated in step 716, the emulation system 100 may be programmed to notify a run time manager (i.e., a debugger) of the state discrepancy.

In one embodiment, the emulation system 100 may be configured to automatically adjust the debug sensitivity level (e.g., by adjusting the number of executable steps performed by the master process 630 before performing a state comparison. This automatic adjustment may respond by processing a number of executable steps in both the master process 630 and the slave processes 610 (FIG. 6) in light of the number of executable steps processed between the last confirmation point in the execution of the translated code and the synchronization point 638 in the translated code cache 636. Furthermore, the automatic adjustment may respond by decreasing the number of executable steps performed by the master process 630 and the slave process 610 prior to subsequent state comparisons. In this way, the emulation system 100 can be programmed to efficiently identify the location of a flawed translation in the translated code. Identifying the location of a flawed translation could involve automatically restarting both emulations (i.e., the interpreter/emulator 102 and the JIT/translator emulator 632) from the beginning of the original code in circumstances where the emulation system 100 failed to pinpoint the exact location (i.e., the execution step) where the divergence occurred. For example, if one of the emulated states could not be successfully restored as may be the case when memory is corrupted, the emulation system 100 may be programmed to reinitialize the interpreter/emulator 102 and the JIT/translator emulator 632 and restart the emulation.

In an alternative embodiment, the emulation system 100 may be configured to interact with one or more applications (i.e., programs) configured to assist an operator of the application(s) in “debugging” the flawed translation. It will be appreciated that the “debugging” applications may contain a user interface that enables the application to respond to user-designated debug-sensitivity levels when performing subsequent execution runs and state comparisons in an attempt to isolate and/or otherwise identify the location of the flawed translation.

While particular embodiments of the invention have been disclosed in detail in the foregoing description and drawings for purposes of example, it will be understood by those skilled in the art that variations and modifications thereof can be made without departing from the scope of the invention as set forth in the following claims.

1. A method for verifying the accurate execution of a program written for an original computer system on a different host computer system, comprising the steps of:
fetching program code;
translating the program code;
emitting translated program code into at least one code cache;
executing translated program code within the at least one code cache, wherein executing generates a first emulated state;
interpreting program code, wherein interpreting generates a second emulated state; and
comparing the first emulated state with the second emulated state.

2. The method of claim 1, wherein the step of fetching program code comprises fetching program instructions with an emulator.

3. The method of claim 2, wherein the emulator is an interpreter/emulator.

4. The method of claim 1, wherein the step of translating the program code comprises translating program instructions with a just-in-time translator.

5. The method of claim 1, wherein the step of emitting translated program code into at least one code cache comprises emitting translated program code into the at least one code cache via an application-programming interface.

6. The method of claim 1, wherein the step of comparing occurs after the translating and interpreting steps have processed a corresponding number of executable instructions from the program code.

7. The method of claim 1, further comprising the step of emulating actions that would have been performed by the original computer system during execution.

8. The method of claim 1, further comprising the step of, prior to emitting translated program code, growing a code fragment by linking program instructions together.

9. The method of claim 8, wherein the step of linking program instructions together comprises linking program instructions together with a just-in-time compiler.

10. A virtual system for verifying execution of translated program code on a host system, comprising:
means for translating original program code;
means for communicating the translated program code into a memory device;
means for manipulating the translated program code to generate a first emulation state;
means for interpreting the original program code, wherein the means for interpreting generates a second emulation state; and
means for comparing the first and second emulation states.

11. The system of claim 10, wherein the means for translating the original program code comprises a just-in-time translator.

12. The system of claim 10, wherein the means for communicating the translated program code into a memory comprises an application-programming interface.

13. The system of claim 10, wherein the means for interpreting comprises an accurate emulation of the program code as executed on hardware other than the host system.

14. The system of claim 10, wherein the means for comparing comprises processing a corresponding number of executable instructions from the original program code in both the means for translating and the means for interpreting.

15. The system of claim 10, further comprising means for emulating actions that would have been performed during execution by an original computer system for which the original program code was written.

16. An emulation program configured to emulate an original computer system for which a program was written, the emulation program stored on a computer-readable medium and comprising:
logic configured to translate program code;
logic configured to emit code fragment translations of program code into at least one code cache;
logic configured to execute the code fragments within the at least one code cache;
logic configured to interpret the program code; and
logic configured to compare a state generated by the logic configured to interpret with a state generated by the logic configured to translate.

17. The program of claim 16, wherein the logic configured to translate the program code comprises a just-in-time translator.

18. The program of claim 16, wherein the logic configured to emit code fragment translations comprises an application-programming interface.

19. The program of claim 16, wherein the logic configured to interpret program code accurately emulates the execution of the program code on the original computer system for which the program was written.

20. A system for executing program code that was written for an original computer system on a different host computer system, comprising:
an emulator;
a translator;
a virtual machine that comprises a dynamic execution-layer interface including a core having at least one code cache in which code fragments can be cached and executed; and
an application-programming interface that links the translator to the virtual machine.

21. The system of claim 20, wherein the emulator comprises an interpreter/emulator.

22. The system of claim 20, wherein the translator comprises a just-in-time translator.

23. The system of claim 20, wherein the translator comprises a translated code cache.

24. The system of claim 23, wherein the translated code cache comprises a synchronization point.

25. The system of claim 24, wherein the synchronization point suspends the translator and initializes a sequence coordinator.

26. The system of claim 25, wherein the sequence coordinator directs the execution of the emulator responsive to translator data.

27. The system of claim 26, wherein the translator data comprises an indication of the number of executed steps traversed by the translator over the program code.

28. A method for verifying the execution of translated program code, comprising:
identifying program code designated for verification;
fetching a portion of the program code;
translating the portion of the program code;
using a controller configured to handle asynchronous events to execute translated code from a code cache;
generating translator information indicative of the progress of the translating step over the program code;
storing a first state responsive to the translating step;
advancing an interpreter in response to the translator information;
storing a second state responsive to the interpreter; and
comparing the first and second states.

29. The method of claim 28, further comprising:
setting a debug sensitivity level when the comparing step indicates a discrepancy between the first and second states.

30. The method of claim 28, further comprising:
accessing the contents of a successful state verification when the comparing step indicates a discrepancy between the first and second states.

31. The method of claim 30, further comprising:
adjusting the debug sensitivity level;
adjusting both the translating step and the interpreter to reflect the contents of the successful state verification;
refetching program code associated with a last verified executable step from the program code; and
repeating the translating, using, generating, storing a first state, advancing, storing a second state, comparing steps to isolate a flawed translation generated state.

32. The method of claim 30, further comprising:
notifying a run time manager of a state discrepancy.
